(19) United States
(12) Patent Application Publication
(10) Pub. No.: US 2004/0254725 A1
(43) Pub. Date: Dec. 16, 2004

(54) System for locating and addressing the lights of a beacon network

(76) Inventor: Eric Douville, Nice (FR)

Correspondence Address: James C Lydon, Suite 100, 100 Daingerfield Road, Alexandria, VA, 22314, US

(21) Appl. No.: 10/495,982

(22) PCT Filed: Nov. 19, 2002
(86) PCT No.: PCT/FR02/03953

(30) Foreign Application Priority Data
Nov. 19, 2001 (FR) 01/14950

(51) Int. Cl. G01C 21/32

(52) U.S. Cl. 701/213; 701/200

(57) ABSTRACT

System for locating and addressing the lights In a lighting or navigation system including a central control (10), an electrical distribution line (12), a plurality of lights (16-1 to 16-m) linked individually or in groups to the electrical distribution line by means of a communication and control module (14-1 to 14-n). According to the main characteristic of the invention, each communication and control module (14-1 to 14-n) is equipped with a GPS (Global Positioning System) automatically transmitting its geographical position and therefore the geographical position of the light or lights (16-1 to 16-m) of the group to the central control (10).

### TECHNICAL FIELD

The present invention relates to the geographic location of the lamps of a lighting system or the like and relates in particular to the geographic location and addressing of the lights of a navigation system.

### STATE OF THE ART

The navigation systems to which the present invention relates are public lighting systems or any other similar lighting or navigation system. These systems are made up of one or more circuit sections on which a plurality of lamps or markers are mounted in series or in parallel. The large number of lamps or markers mounted on these systems necessitates the installation of a location or addressing system for each lamp or marker required for controlling and monitoring their state of operation. In the case of a navigation system for an airport runway, this location system is also required for operating the lights including, for example, their illumination, the adjustment of their brightness and their intensity. Such location systems exist today and consist, during installation of the system, in locating each light or group of lights via an address corresponding to the geographical location of the light, the address then being programmed into a central control In communication with each light of the system. Each light is then equipped with a transmitter capable of sending relative information on the state of the light to the central control by cable or radio transmission. In the case of a breakdown, the central control then registers the address of the defective light. The new light which is put in place is then also parameterised in order to be located by the central control. The addressing of each light and parameterisation thereof are generally manual and therefore tedious operations and give rise to errors.

With such systems, the operations for adding lights or carrying out modifications in an already parameterised system also give rise to errors and malfunctions.

The location system can also be made up of a relay system capable of evaluating a ratio of current flowing in a section of the light system to a reference current and of transmitting an alarm signal when this ratio is lower than a threshold value corresponding to the nominal operation of all the lights of the section comprising the relay system. This type of system allows the location of the section comprising at least one defective light and avoids the manual operations which consist in registering the address of each light. Unfortunately, this system also requires adjustment of the relay system after the replacement of a light and does not allow precise location and addressing of the defective light.

### DISCLOSURE OF THE INVENTION

It is for this reason that a first aim of the invention is to provide a system for addressing the lights in a lighting or navigation system which avoids the parameterisation of each light during its installation or replacement.

A second aim of the invention is to provide a system for the automatic geographical location of the lights in a lighting or navigation system during their installation or replacement.

The object of the invention therefore relates to a system for locating and addressing the lights In a lighting or navigation system including a central control, an electrical distribution line and a plurality of lights linked individually or in groups to said distribution line by means of a communication and control module. According to the main characteristic of the invention, each communication and control module is equipped with GPS (Global Positioning System) which automatically transmits its geographical position and therefore the geographical position of the light or lights of the group to the central control.

### BRIEF DESCRIPTION OF THE FIGURES

The aims, objects and characteristics of the invention will become more clearly apparent on reading the following description with reference to the drawings, in which:

FIG. 1 shows a parallel navigation system according to a preferred embodiment of the invention,

FIG. 2 shows a block diagram of a communication and control module.

### DETAILED DESCRIPTION OF THE INVENTION

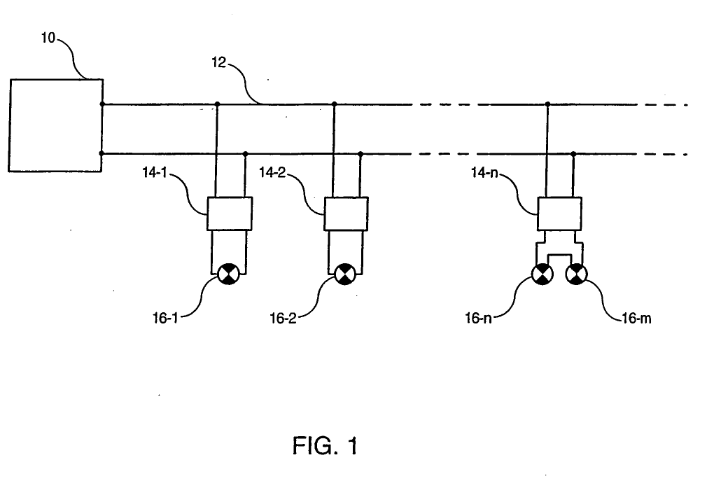

According to a preferred embodiment of the Invention schematically shown in FIG. 1, the lighting or navigation system is a circuit made up of a central control 10 and a parallel electrical distribution line 12 including a plurality of navigation lights 16-1 to 16-m, all of which are linked individually or In groups to a communication and control module 14-1 to 14-n. Communication module 14-1 to 14-n can also be integrated into the light and in this case there is an equal number of modules and lights.

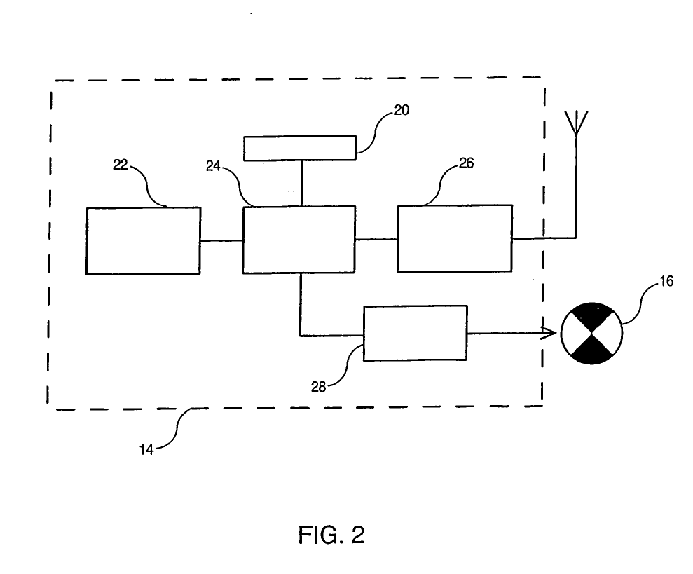

Referring to FIG. 2, each communication and control module 14 has a serial number stored In a register 20, inserted into its memory during its manufacture for example, this being a unique identification number which distinguishes it from the others. During the installation of the lighting system, each light or group of lights is installed with its communication and control module integrated or not into the light. The installation of each module is carried out without establishing any correspondence between the address or the serial number of the module and its geographical location. Each module 14 is made up of dialogue electronics 24 which are linked by a communication interface 22 to central control 10 so as to receive and send information. When powering up the lighting system, the central control polls the modules one by one using a transmitter, by incrementing the serial number. When there is correspondence between the serial number of the module and the number incremented by the central control, the module is connected and responds to the central control by sending these geographical coordinates which are recognised automatically by GPS receiver 26. When all of the modules are connected to the central control, a precise mapping of the position of the lights and modules of the system is established and displayed at the central control using a screen-type user interface for example. Lamp 16 receives information from power electronics 28 according to the instructions from control electronics 24. Thus, each light can have its intensity or brightness adjusted individually or it can be illuminated individually or not.

GPS receiver 26 allows the automatic addressing of each communication and control module and therefore of each light or group of lights. It thus avoids the parameterisation of each light or group of lights during the installation of the light system and during the replacement of one or more defective lights.

The location and addressing system according to the invention allows for the precise location of each communication and control module and therefore of each light or group of lights of the system within a few metres, irrespective of the size of the system and the number of system lights.

The location and addressing system according to the invention also enables the maintenance engineer, who is also equipped with a GPS receiver, to arrive exactly at the position of the module or of the defective light.

1-5. (Canceled)

6. A system for locating and addressing the lights in a lighting or navigation system comprising a central control, an electrical distribution line, a plurality of lights linked individually or in groups to said electrical distribution line by at lease one communication and control module;
wherein each communication and control module is equipped with GPS (Global Positioning System) adapted to automatically send its geographical position and therefore the geographical position of the light or lights of the group to said central control.

7. The system of claim 6, wherein said central control has a screen-type user interface so as to display a mapping of the position of said lights located by GPS.

8. The system of claim 6, wherein each communication module containing a GPS receiver is integrated into a light.

9. The system of claim 6, wherein each communication and control module has a serial number stored in a register.

10. The system of claim 6, wherein the geographical position of a light or group of lights is transmitted to said central control when the serial number stored in said register of associated communication and control module corresponds to the serial number previously transmitted by said central control.
